(19) United States
(12) Patent Application Publication
(10) Pub. No.: US 2024/0411947 A1
(43) Pub. Date: Dec. 12, 2024

(54) INFORMATION PROVISION SYSTEM, INFORMATION PROVISION METHOD, AND STORAGE MEDIUM STORING INFORMATION PROVISION PROGRAM

(71) Applicant: Mitsubishi Electric Corporation, Tokyo (JP)

(72) Inventors: Shingo MINE, Tokyo (JP); Masahiro ABUKAWA, Tokyo (JP)

(73) Assignee: Mitsubishi Electric Corporation, Tokyo (JP)

(21) Appl. No.: 18/810,187

(22) Filed: Aug. 20, 2024

Related U.S. Application Data
(63) Continuation of application No. PCT/JP2022/017070, filed on Apr. 4, 2022.

(51) Int. Cl. G06F 30/17

(52) U.S. Cl. CPC G06F 30/17

(57) ABSTRACT

An information provision system includes a design data management unit to manage device design data regarding design of a target device, including one or more items of data out of machine design data as data regarding machine design of the target device, electric design data as data regarding electric design of the target device, and control design data as data regarding control design of the target device, by handling each of a plurality of elements constituting the device design data as a unit and linking relevance information indicating relevance between elements in the plurality of elements, with each element, a design data extraction unit to generate disclosure design data by extracting a part corresponding to a designated disclosure range from the device design data in units of elements and by referring to the relevance information, and a design data issuance unit to issue the disclosure design data.

### CROSS-REFERENCE TO RELATED APPLICATION

This application is a continuation application of International Application No. PCT/JP2022/017070 having an international filing date of Apr. 4, 2022.

### BACKGROUND OF THE INVENTION

### 1. Field of the Invention

The present disclosure relates to an information provision system, an information provision method and an information provision program.

### 2. Description of the Related Art

There are cases where a device manufacturer (e.g., information provider) that manufactures a product by installing a target component (referred to also as a “target device”) supplied from a component supplier (e.g., information recipient) in the product provides the component supplier with information necessary for analysis for inspecting the performance of the target component (e.g., shape information regarding the product in which the target component is installed). In such cases, the device manufacturer needs to execute work of determining a disclosure range as a range of information that may be provided to the component supplier. To support this work, there has been proposed a design support device that determines the disclosure range based on an evaluation result (e.g., trading results) regarding the component supplier and extracts the information necessary for the analysis of the target component from information in the disclosure range (see Patent Reference 1, for example). Similarly, there are cases where the device manufacturer as the information provider provides a device user as the information recipient with device design data, and also in such cases, the device manufacturer needs to execute the work of determining the disclosure range.

Patent Reference 1: Japanese Patent Application Publication No. 2018-147012 (claim 1 and FIG. 1, for example).

However, various types of trouble can occur in the actual worksite even though the device user as the information recipient has a request to be able to view design data, provided from the device manufacturer, upon the occurrence of trouble, and thus it is difficult for the device manufacturer to previously and appropriately set the disclosure range of the device design data provided to the information recipient by presuming trouble that can occur.

### SUMMARY OF THE INVENTION

An object of the present disclosure is to provide an information provision system, an information provision method and an information provision program that make it possible to issue the device design data in an appropriate disclosure range.

An information provision system in the present disclosure includes processing circuitry to manage device design data regarding design of a target device provided to a device user, including one or more items of data out of machine design data as data regarding machine design of the target device, electric design data as data regarding electric design of the target device, and control design data as data regarding control design of the target device, by handling each of a plurality of elements constituting the device design data as a unit and linking relevance information indicating relevance between elements in the plurality of elements, with each element, to generate disclosure design data by extracting a part corresponding to a designated disclosure range from the device design data in units of elements and by referring to the relevance information, and to issue the disclosure design data while managing the device user's access right and the device user's viewable period regarding the disclosure design data.

An information provision method in the present disclosure is a computer. The information provision method includes managing device design data regarding design of a target device provided to a device user, including one or more items of data out of machine design data as data regarding machine design of the target device, electric design data as data regarding electric design of the target device, and control design data as data regarding control design of the target device, by handling each of a plurality of elements constituting the device design data as a unit and linking relevance information indicating relevance between elements in the plurality of elements, with each element, generating disclosure design data by extracting a part corresponding to a designated disclosure range from the device design data in units of elements and by referring to the relevance information, and issuing the disclosure design data while managing the device user's access right and the device user's viewable period regarding the disclosure design data.

According to the present disclosure, the disclosure design data in an appropriate range can be issued.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically showing the configuration of an information provision system according to a first embodiment;

FIG. 2 is a diagram showing an example of the hardware configuration of a server in FIG. 1;

FIG. 3 is a diagram showing an example of the hardware configuration of a manufacturer-side PC (Personal Computer) in FIG. 1;

FIG. 4 is a flowchart showing an example of the operation of the manufacturer-side PC in FIG. 1;

FIG. 5 is a flowchart showing an example of the operation of a server in FIG. 1;

FIG. 6 is a flowchart showing an example of the operation of a user-side PC in FIG. 1;

FIG. 7 is a diagram schematically showing the configuration of an information provision system according to a second embodiment;

FIG. 8 is a diagram schematically showing the configuration of an information provision system according to a third embodiment;

FIG. 9 is a diagram schematically showing the configuration of an information provision system according to a fourth embodiment;

FIG. 10 is a diagram schematically showing the configuration of an information provision system according to a fifth embodiment;

FIG. 11 is a flowchart showing the operation of the information provision system according to the fifth embodiment; and

FIG. 12 is an explanatory diagram showing the operation of the information provision system according to the fifth embodiment.

### DETAILED DESCRIPTION OF THE INVENTION

An information provision system, an information provision method and an information provision program according to each embodiment will be described below with reference to the drawings. The following embodiments are just examples and it is possible to appropriately combine embodiments and appropriately modify each embodiment.

### (1) First Embodiment

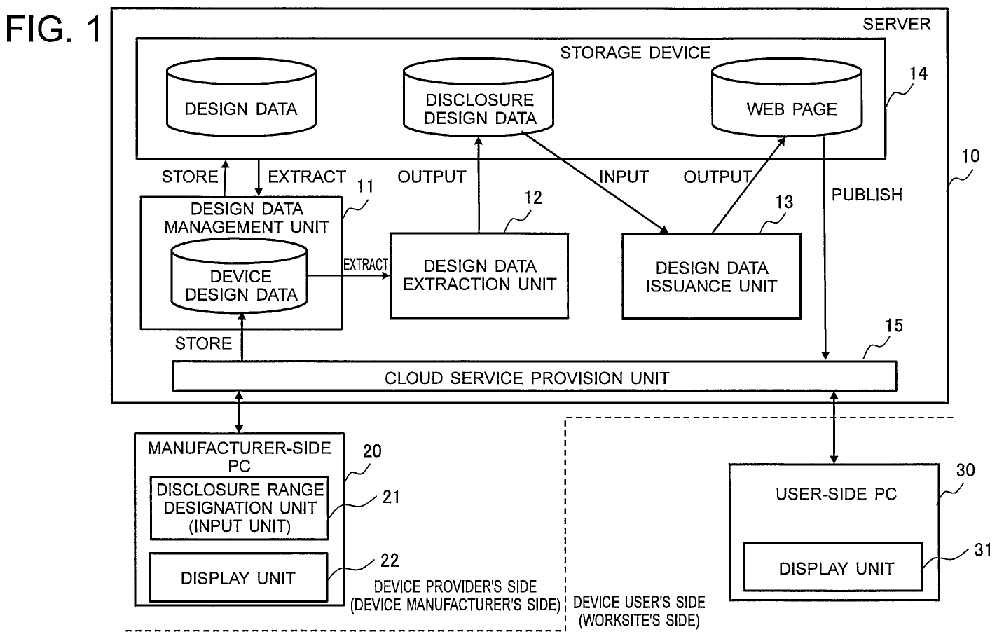

FIG. 1 is a block diagram schematically showing the configuration of an information provision system according to a first embodiment. The information provision system according to the first embodiment is formed with a server 10 as a server computer provided on a network and a manufacturer-side PC 20 as a computer on a device provider's side. The information provision system according to the first embodiment provides a user-side PC 30 as a computer on a device user's side with disclosure design data generated from device design data. The device provider provides a target device (that can also be a target component, a target material or the like) to the device user. The device provider does not necessarily have to be the manufacturer of the target device but can also be a person or company having the authority to manage the device design data of the target device. The device user is an entity that acquires the target device, does not necessarily have to use the target device by itself, and can also be a person or company having the authority to manage the target device.

As shown in FIG. 1, the server 10 includes a design data management unit 11, a design data extraction unit 12, a design data issuance unit 13, and a storage device 14 that stores information. Further, the server 10 includes a cloud service provision unit 15.

The design data management unit 11 manages the device design data regarding the design of the target device provided to the device user. The device design data includes one or more items of data out of machine design data as data regarding machine design of the target device, electric design data as data regarding electric design of the target device, and control design data as data regarding control design of the target device. The design data management unit 11 manages the device design data by handling each of a plurality of elements constituting the device design data as a unit (namely, in units of elements) and linking relevance information indicating relevance between elements in the plurality of elements, with each element. Concrete examples of the elements in the machine design data can be a 3D (three-dimensional) shape of a component, a shape of a surface of the component, a shape of an edge of the component, and so forth in a component file of the machine design data. Concrete examples of the elements in the electric design data can be parts in an electric design circuit diagram (e.g., circuit parts of a liquid crystal display (LCD) module in the circuit diagram) in the electric design data. A concrete example of the element in the control design data can be an element in a ladder diagram in the control design data.

The design data extraction unit 12 generates the disclosure design data by extracting a part corresponding to a designated disclosure range from the device design data in units of elements and by referring to the relevance information. For example, the design data extraction unit 12 generates the disclosure design data by extracting elements corresponding to the designated disclosure range and elements linked with the elements corresponding to the designated disclosure range as the part corresponding to the designated disclosure range. It is also possible for the design data extraction unit 12 to extract the part corresponding to the designated disclosure range from individual device design data alone (e.g., the machine design data alone, the electric design data alone, or the control design data alone) without using the relevance information on the design data.

The design data issuance unit 13 issues the disclosure design data while managing an access right of the device user and viewable period of the device user regarding the disclosure design data.

In the information provision system shown in FIG. 1, the manufacturer-side PC 20 as a PC of the information provider (e.g., the device manufacturer) provides the user-side PC 30 as a PC of the information recipient with part or the whole of the device design data (which can include device parameter adjustment data), directly or by processing the data, as the disclosure design data. The method of providing the disclosure design data can be transmission of the disclosure design data via a network such as the Internet. The method of providing the disclosure design data can be sharing of data in a cloud environment. Further, the method of providing the disclosure design data can be provision by using a record medium such as a CD (compact disc) or a DVD (digital versatile disc) to which the disclosure design data has been written, provision by attaching the disclosure design data to an email and transmitting the email, or the like.

In general, the device design data is generated by using software as a CAD (Computer Aided Design) tool installed in the manufacturer-side PC 20 and is stored in a storage device of the manufacturer-side PC 20 or the server 10 as a database (DB).

The device parameter adjustment data is generated by using, for example, a testing target device connected to the manufacturer-side PC 20 and is stored in a storage device as a database (DB), namely, a device parameter adjustment data DB. The testing target device is a device having the same functions as the target device delivered to the device user as the information recipient.

The disclosure design data provided to the user-side PC 30 of the information recipient is stored in a storage device of the user-side PC 30. The user can use the disclosure design data acquired from the server 10 for the operation, maintenance, repair and the like of the target device by having the disclosure design data displayed on a display unit 31 as a display device such as a liquid crystal display.

The design data extraction unit 12 acquires the device design data (which can include the device parameter adjustment data) as data regarding the design of the target device from the design data management unit 11. The device parameter adjustment data is data regarding device parameters that determine the operation of the target device. The design data extraction unit 12 extracts device design data according to disclosure range information designated by a disclosure range designation unit 21 and generates the disclosure design data to be provided to the user-side PC 30 from the extracted device design data. The design data extraction unit 12 generates the disclosure design data to be provided to the information recipient by processing the extracted device design data. The processing of the extracted device design data is, for example, one of a process of generating the disclosure design data by concealing the extracted data by means of encryption, a process of generating the disclosure design data by changing a level (i.e., detail level) according to the LOD (level of detail) technology, a process of generating the disclosure design data by replacing the extracted device design data with different data, and filtering of extracting particular data from the device design data.

In general, the device design data is made up of the machine design data, the electric design data and the control design data. The device design data is generated by using a CAD tool installed in a PC. The machine design data includes data of a file generated by using a CAD tool for the machine design. The electric design data includes data of a file generated by using a CAD tool for the electric design. The control design data includes data of a file for a program for the control design.

The design data extraction unit 12 may generate the disclosure design data by integrating the device design data and the device parameter adjustment data.

The device design by the device manufacturer is generally executed in a flow like order receipt, machine design, electric design, control design, and startup-adjustment. The order receipt involves explanation/proposal of the target device (or target facility or target component) or the like by using a device catalog or the like. The machine design is executed based on machine specifications of the target device and includes preparation of assembly drawings, component drawings and so forth. The electric design is executed based on electric specifications of the target device and includes preparation of electric circuit diagrams, component arrangement diagrams, wiring diagrams and so forth. The control design is executed based on control specifications and includes preparation of a program and so forth.

The device design data is the outcome of the designing and includes, for example, electronic data of a specification document, design drawings, a design document, drawings, models, an instrument name table, an instruction manual and so forth. Specifically, the electronic data may include machine CAD data, electric CAD data, a control program, document files, image files, animation files, video files and so forth.

The device design data may include process design data. The process design data is data regarding a process from product design to production deployment included in the device design data. For example, the device design data may include line design data, data as a result of simulation by line simulator software, design/production management information based on CAD/CAM (Computer Aided Manufacturing)/CAE (Computer Aided Engineering), and so forth.

The machine design data includes shape data and mechanism data. Specifically, the machine design data includes data regarding drafting, processing, assembly, maintenance, standard/design criteria, strength calculation, performance calculation, material-component availability, machine introduction cost, machine running cost, delivery date, easiness of assembly, maintainability, designability, stability of quality, safety, environmental load, and work regarding analysis. In the machine design, the structure and the mechanism of each machine element (screw, gear, motor, reduction gear, bearing, ball screw, linear guide, cylinder, hydraulic/pneumatic element, link, spring, seal, etc.) and each unit machine are drawn up as drawings, and materials, shapes and dimensions are determined so that strength and a deformed state of each component of the structure and the mechanism fit in permissible ranges. Further, when an already-existing machine element or unit machine is used, the shape, the dimensions, the material and so forth of each component are determined based on technical data of the machine element or unit machine. Based on the determined items, there are prepared a design document, a project diagram, data as the result of designing attributes and the like (e.g., shape, mechanism, color, material, etc.) of the device, document files of the specification document and the like, detailed drawings of components (component drawings), partial assembly drawings, assembly drawings of the whole machine, production drawings into which information for the production has been incorporated, and so forth.

The machine CAD data is data outputted from machine CAD software. As data formats, there are a native file that can be handled only on software from its respective vendor and an intermediate file that is used for data exchange between vendors. For example, as the machine CAD data, there are two-dimensional CAD data of an assembly drawing of the device, a detailed drawing of a component, or the like designed by using two-dimensional CAD software, three-dimensional CAD data of an assembly drawing of the device, a detailed drawing of a component, or the like designed by using three-dimensional CAD software, and an intermediate file for data exchange between CAD software and CAD software. Concrete examples of the machine CAD data include IGES (Initial Graphics Exchange Specification), STEP (Standard for the Exchange of Product model data), PARASOLID, JT (Jupiter Tessellation), and so forth.

The electric design data is design data regarding electricity. The electric design data is data outputted from electric CAD software, for example. Specifically, the electric design data includes determination of electric specifications, preparation of electric circuit diagrams, preparation of wiring diagrams (e.g., power system wiring diagrams and control system wiring diagrams), preparation of drawings describing shapes of connectors or the like, and so forth. The determination of the electric specifications includes selection of an inverter, selection of a breaker as a wiring breaker, determination of a control panel, a control console and a distribution panelboard, selection of a sensor and a motor, and so forth. The electric CAD data is data outputted from the electric CAD software.

The control design data is design data regarding the control, such as data that determines where, about what, and how measurement and control should be performed in the designing of a measurement control system, for example. The control design includes design of a PLC program and production of a touch panel. The control design data can include, for example, data obtained by executing the control design of the device by using software that generates the PLC program, drawing data designed by using software that generates the drawing data of the programmable indicator, document files or a DB of the specification document and the like associated with these data, and so forth. Specifically, the control design data can include a ladder diagram, drawing data for an indicator, and so forth.

The device parameter adjustment data is data regarding the parameters of the device. The device parameter adjustment data is, for example, history data obtained when the parameters of the device were adjusted in the past or data as a result of calculating recommendation values of device parameter adjustment by means of machine learning. Specifically, a CSV file, or data recorded in a DB or the like corresponds to the device parameter adjustment data. For example, the device parameter adjustment data can include data of setting parameters of the device, data of materials, data of environment (temperature, humidity, etc.), data obtained as a result of a test, and so forth. Examples of the device parameters include
1) Setting parameter information regarding the settings of the device, such as set values of the device, customization design values, the model name, and ON/OFF of functions,
2) Material parameter information regarding the materials of the device, such as quality, properties, etc. of each material,
3) Environment parameter information regarding the environment in which the device is used, such as temperature, humidity and atmospheric pressure,
4) Test parameter information regarding a test of the result of the device parameter adjustment, such as an operation time and a processing result, and so forth.

It is also possible to register such device parameters in a database and handle the registered device parameters as the device parameter adjustment data.

Worksite data is data collected at a worksite where the device user uses the device. For example, the worksite data is data collected from the device or sensors adjunct to the device. Specifically, a CSV file, or data recorded in a DB or the like corresponds to the worksite data. For example, data regarding operational status, failure or maintenance of the device, operational log data of the device, and log data of operations on the device by a person correspond to the worksite data. Specifically, the worksite data can include, for example, data of the device collected by “Edgecross”, produced by Edgecross Consortium as an open software platform in an edge computing region between the manufacturing site and IT, and stored in the CSV file format or in a DB and an operational log file of the device recorded by a data logging function of a sequencer and stored in the CSV format or an operation log file of the device recorded by a programmable indicator in the CSV or Unicode text file format. Such worksite data may be registered in a database in addition to the design data and handled as the worksite data.

The disclosure design data can also be integrative data obtained by integrating various types of data. The integrative data is an integrative model as data for integrative management of the machine design data, the electric design data and the control design data. Specifically, the integrative model is described in a standard data format with published specifications based on XML, such as AutomationML. For example, the design data extraction unit 12 extracts information by XML processing technology from the design data managed in the XML format in the design data management unit 11 and generates an XML file including the extracted information. For example, the design data issuance unit 13 embeds the XML file generated by the design data extraction unit 12 in a web page, issues the web page to the device user, and has the web page displayed on a browser in the device user's environment. In this case, the design data issuance unit 13 sets an access right and the viewable period in regard to the issued web page and thereby enables management of a viewer and the viewable period on the device user's side.

In the first embodiment, the configuration on the device provider's side (i.e., the device manufacturer's side) is formed with the manufacturer-side PC 20 and the server 10, and the configuration on the device user's side (i.e., the worksite's side) is formed with the user-side PC 30. However, in cases where the manufacturer-side PC 20 and the user-side PC 30 are connected to be capable of communication with each other, the configuration on the device provider's side may be formed with the manufacturer-side PC 20 alone. In this case, the design data management unit 11, the design data extraction unit 12, the design data issuance unit 13 and the storage device 14 are provided in the manufacturer-side PC 20.

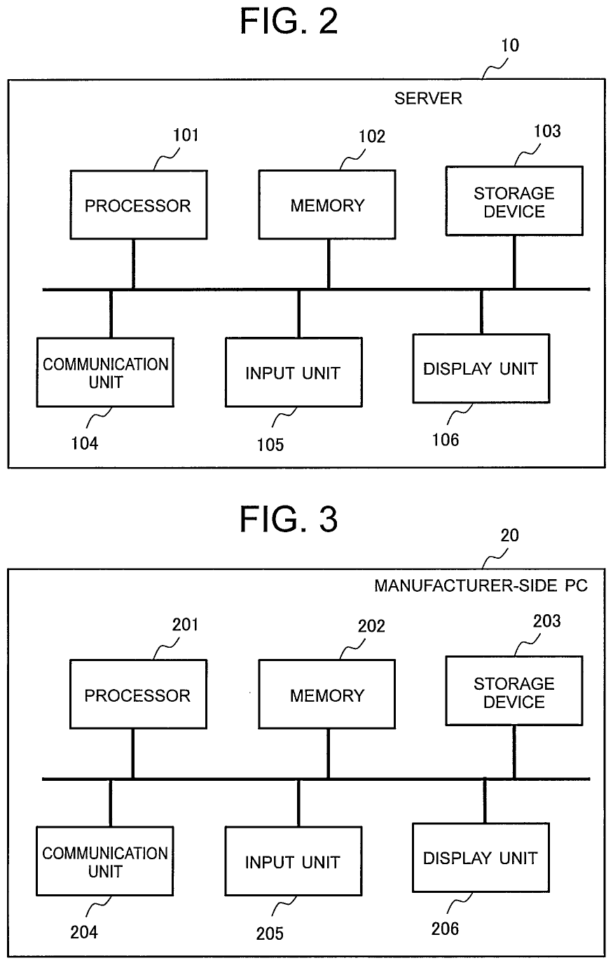

FIG. 2 is a diagram showing an example of the hardware configuration of the server 10 in FIG. 1. The server 10 includes a processor 101, a memory 102, a storage device 103, a communication unit 104, an input unit 105 and a display unit 106. The processor 101 is a CPU (Central Processing Unit) or the like. The memory 102 is, for example, a volatile semiconductor memory such as a RAM (Random Access Memory). The storage device 103 is a nonvolatile storage device such as a hard disk drive (HDD) or a solid state drive (SSD). The communication unit 104 executes communication with other devices via the network. The input unit 105 is an operation unit such as a keyboard as an input interface. The display unit 106 is a display device such as a liquid crystal display.

Functions of the server 10 may be implemented by processing circuitry. The processing circuitry can be either dedicated hardware or the processor 101 executing a program stored in the memory 102. The processor 101 can be any one of a processing device, an arithmetic device, a microprocessor, a microcomputer and a DSP (Digital Signal Processor).

In the case where the processing circuitry is dedicated hardware, the processing circuitry is, for example, a single circuit, a combined circuit, a programmed processor, a parallelly programmed processor, an ASIC (Application Specific Integrated Circuit), an FPGA (Field-Programmable Gate Array) or a combination of some of these circuits.

In the case where the processing circuitry is the processor 101, an information provision program according to the first embodiment is implemented by software, firmware or a combination of software and firmware. The software and the firmware are described as programs and stored in the memory 102. The processor 101 is capable of implementing the functions of the units shown in FIG. 1 by reading out and executing the information provision program stored in the memory 102 as a storage medium (i.e., a record medium). The storage medium may be a non-transitory computer-readable storage medium storing a program such as the information provision program. Incidentally, it is also possible to implement part of the server 10 by dedicated hardware and implement part of the server 10 by software or firmware. As above, the processing circuitry is capable of implementing the functions of the functional blocks shown in FIG. 1 by hardware, software, firmware or a combination of some of these means.

FIG. 3 is a diagram showing an example of the hardware configuration of the manufacturer-side PC 20 in FIG. 1. The manufacturer-side PC 20 includes a processor 201, a memory 202, a storage device 203, a communication unit 204, an input unit 205 and a display unit 206. Functions of these components are the same as the functions of the processor 101, the memory 102, the storage device 103, the communication unit 104, the input unit 105 and the display unit 106 shown in FIG. 2. Incidentally, the hardware configuration of the user-side PC 30 is the same as that of the manufacturer-side PC 20 shown in FIG. 3.

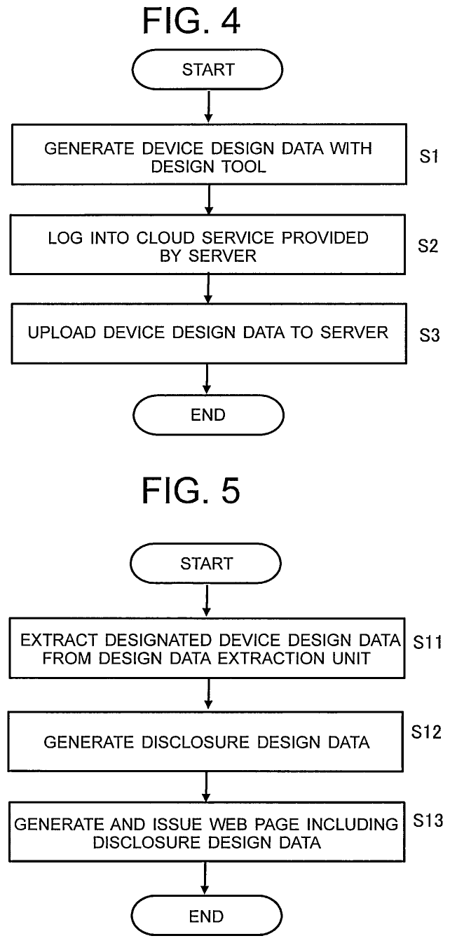

FIG. 4 is a flowchart showing an example of the operation of the manufacturer-side PC 20 in FIG. 1. The manufacturer-side PC 20 generates the device design data according to operations of a design tool by the designer (step S1), logs into a cloud service provided by the server 10 (step S2), and uploads the device design data to the server 10 (step S3).

FIG. 5 is a flowchart showing an example of the operation of the server 10 in FIG. 1. The design data extraction unit 12 extracts a part corresponding to the designated disclosure range from the uploaded device design data managed by the design data management unit 11 (step S11), and generates the disclosure design data (step S12), and the design data issuance unit 13 generates and issues a web page including the disclosure design data (step S13).

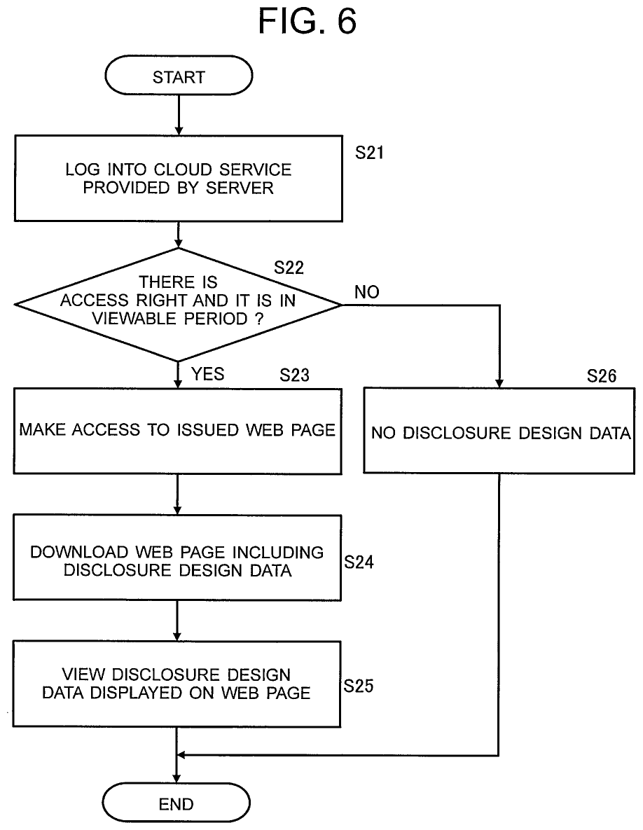

FIG. 6 is a flowchart showing an example of the operation of the user-side PC 30 in FIG. 1. The user-side PC 30 logs into the cloud service provided by the server 10 (step S21), and if there is the access right to the disclosure design data that is desired to be accessed and the time point of the access is in the viewable period (YES in step S22), makes access to the issued web page (step S23) and downloads the web page including the disclosure design data (step S24), by which the disclosure design data becomes viewable (step S24). If there is no access right or the time point of the access is outside the viewable period (NO in step S22), the user-side PC 30 judges that there is no disclosure design data (step S26) and ends the process. While an example of providing the web page to the device user has been shown above, it is also possible to manage the access right and the viewable period by a different method, such as providing the device user with an access right to a DB in the cloud.

In conventional information provision systems, information on the product such as the shape information and analysis information is provided in a static manner at the time of the delivery of the product according to agreements regarding the previously set disclosure range. In contrast, according to the information provision system in this embodiment, the device design data is managed in units of elements, the relevance is managed in units of elements of each item of device design data (the machine design data, the electric design data, the control design data), and the disclosure range of the device design data can be changed by designation by the user. Thus, since the information provision system is configured to make it possible to manage the disclosure design data by setting the access right and the viewable period regarding the disclosure design data and issuing the disclosure design data to the device user, information at a high secrecy level can be provided in a secure manner by determining the access right and the viewable period regarding the information in addition to design data previously disclosed.

Further, the design data extraction unit 12 is capable of generating appropriate disclosure design data corresponding to the designated disclosure range by automatically extracting elements corresponding to the designated disclosure range (e.g., elements in the machine design data) and elements linked with the elements corresponding to the disclosure range (e.g., elements in the electric design data) as the part corresponding to the designated disclosure range.

### (2) Second Embodiment

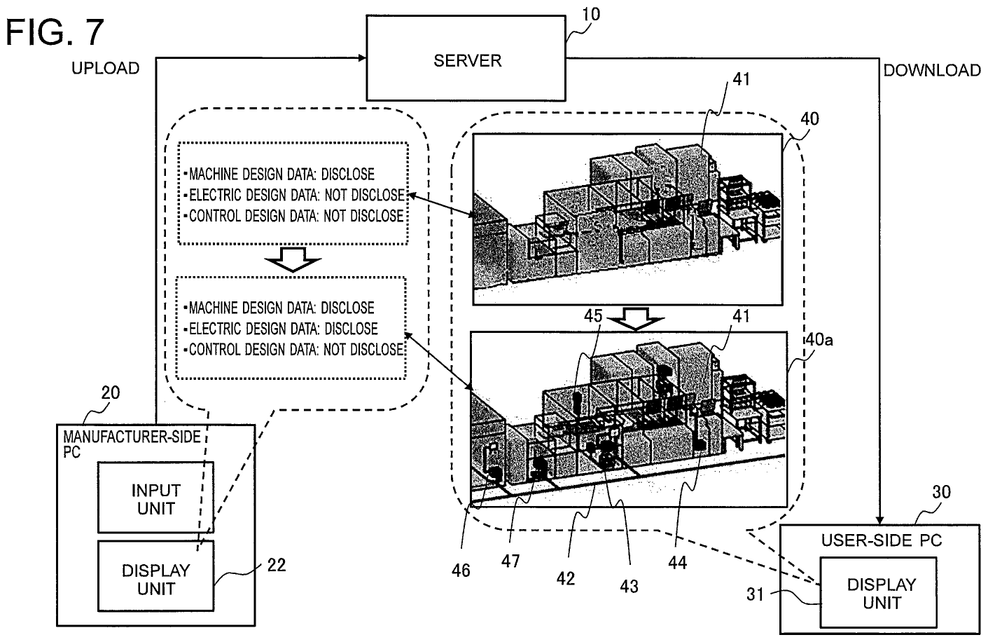

FIG. 7 is a diagram schematically showing the configuration of an information provision system according to a second embodiment. FIG. 1 is also referred to in the description of the configuration of the information provision system according to the second embodiment. The information provision system according to the second embodiment differs from the information provision system according to the first embodiment in the operation of the design data extraction unit 12 and the design data issuance unit 13.

In the second embodiment, the design data extraction unit 12 dynamically modifies the device design data extracted from the design data management unit 11 according to modification of the designated disclosure range and generates modified disclosure design data by extracting a part corresponding to the modified disclosure range from the device design data in units of elements and by referring to the relevance information. The design data issuance unit 13 issues the modified disclosure design data while managing the device user's access right and the device user's viewable period regarding the modified disclosure design data.

In the second embodiment, an account of the manufacturer-side PC 20 is provided with a user interface (UI) for setting disclosure propriety regarding device design data, and it is made possible to modify information regarding the disclosure range in an account of the user-side PC 30 by an operation on the manufacturer-side PC 20. When the disclosure range of the device design data has been modified, the device design data is updated and displayed according to the modification on display software for displaying the device design data in the environment of the user-side PC 30.

FIG. 7 shows a case there the disclosure range has been modified from a state in which “machine design data: disclose”, “electric design data: not disclose” and “control design data: not disclose” to a state in which “machine design data: disclose”, “electric design data: disclose” and “control design data: not disclose”. As indicated as a screen 40 in FIG. 7, when the disclosure range is “machine design data: disclose”, “electric design data: not disclose” and “control design data: not disclose”, an element 41 based on the machine design data is displayed on the display unit of the user-side PC. Further, as indicated as a screen 40a in FIG. 7, when the disclosure range is modified to “machine design data: disclose”, “electric design data: disclose” and “control design data: not disclose”, an element 42 (electric wiring) based on the electric design data and associated with the element 41 and elements 43 to 47 (electric components, meters, etc.) based on the electric design data and associated with the element 41 become viewable on the display unit of the user-side PC in addition to the element 41 based on the machine design data.

For example, when the manufacturer-side PC 20 dynamically modifies the disclosure range in response to a notification of situation of trouble of the target device received from the device user, the image displayed on the display unit of the user-side PC 30 can be modified in real time by the display software of the user-side PC 30 according to the modification of the disclosure range. In other words, the manufacturer-side PC 20 is capable of dynamically modifying the disclosure range of the information provided to the user-side PC 30 according to the situation of the trouble of the target device.

Except for the above-described features, the second embodiment is the same as the first embodiment.

### (3) Third Embodiment

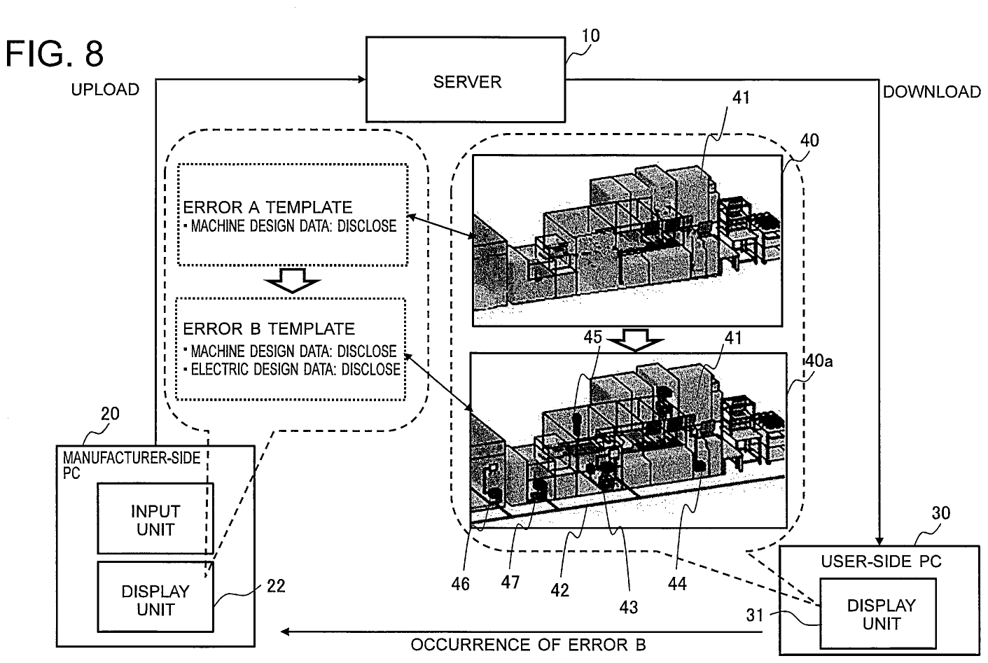

FIG. 8 is a diagram schematically showing the configuration of an information provision system according to a third embodiment. FIG. 1 is also referred to in the description of the configuration of the information provision system according to the third embodiment. The information provision system according to the third embodiment differs from the information provision system according to the first embodiment in the operation of the design data extraction unit 12 and the design data issuance unit 13.

In the information provision system according to the third embodiment, the design data extraction unit 12 previously stores a plurality of templates each determining items of elements of the device design data to be extracted from the design data management unit 11, and when a command for selecting one of the plurality of templates is inputted, generates the disclosure design data by extracting device design data from the design data management unit 11 according to the disclosure range designated by the selected template in units of elements and by referring to the relevance information. The design data issuance unit 13 issues the disclosure design data while managing the device user's access right and the device user's viewable period regarding the modified disclosure design data. In other words, in the third embodiment, templates regarding information to be extracted from the design data management unit 11 are generated, and device design data is automatically extracted from the design data management unit 11 according to a template.

FIG. 8 shows a case there the disclosure range has been modified from a state in which “error A template/machine design data: disclose” to a state in which “error B template/machine design data: disclose/electric design data: disclose”. As indicated as a screen 40 in FIG. 8, when the disclosure range is “error A template”, the element 41 based on the machine design data is displayed on the display unit of the user-side PC. Further, as indicated as a screen 40a in FIG. 8, when the disclosure range is modified to “error B template”, the element 42 (electric wiring) based on the electric design data and associated with the element 41 and the elements 43 to 47 (electric components, meters, etc.) based on the electric design data and associated with the element 41 become viewable on the display unit of the user-side PC in addition to the element 41 based on the machine design data.

The trouble of designating the disclosure range upon each provision of information can be reduced by making the manufacturer-side PC 20 previously generate the templates, for example.

Except for the above-described features, the third embodiment is the same as the first or second embodiment.

### (4) Fourth Embodiment

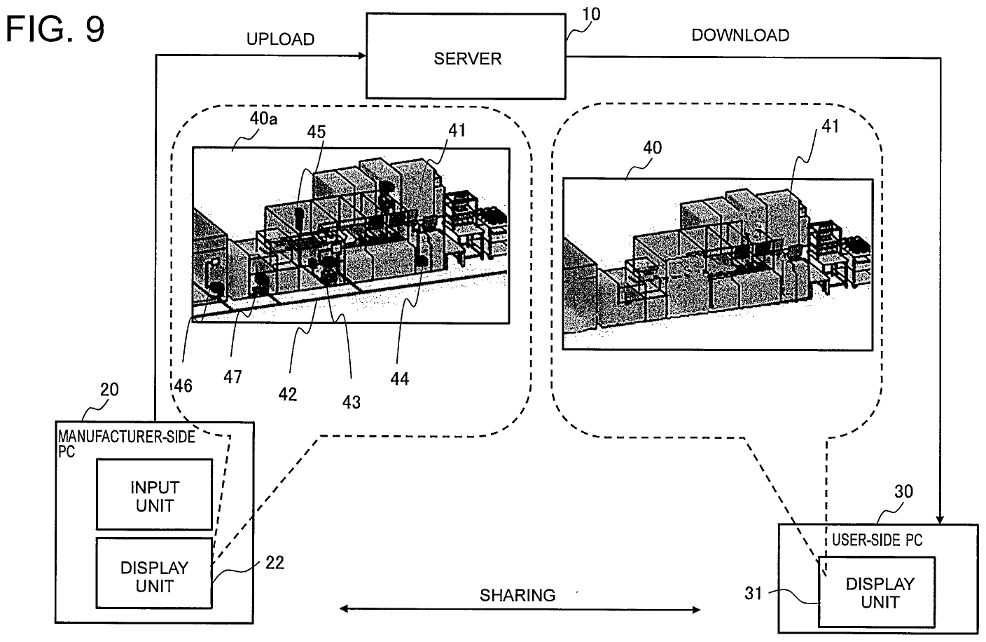

FIG. 9 is a diagram schematically showing the configuration of an information provision system according to a fourth embodiment. FIG. 1 is also referred to in the description of the configuration of the information provision system according to the fourth embodiment. The information provision system according to the fourth embodiment includes a manufacturer-side PC 20 as a computer on the device provider's side managed by the device provider providing the target device and a user-side PC 30 as a computer on the user's side managed by the device user. Further, when a command for sharing the display screen between the display unit of the manufacturer-side PC 20 (first display unit) and the display unit of the user-side PC (second display unit) is inputted, original device design data before designating the disclosure range is displayed on the first display unit while an image based on the disclosure design data issued by the design data issuance unit 13 is displayed on the second display unit.

In other words, when the sharing of the display screen is selected, the manufacturer-side PC 20 displays the device design data with no concealed items, and the user-side PC 30 displays an image based on the disclosure design data generated from the device design data (i.e., the image in any one of the above-described first to third embodiments).

Accordingly, the device design data can be viewed on the manufacturer-side PC 20 with no concealed items as indicated as a screen 40a in FIG. 9, and at the same time, the image based on the disclosure design data (in which elements based on the electric design data are not shown) can be displayed on the user-side PC 30's side as indicated as a screen 40 in FIG. 9.

Except for the above-described features, the fourth embodiment is the same as any one of the first to third embodiments.

### (5) Fifth Embodiment

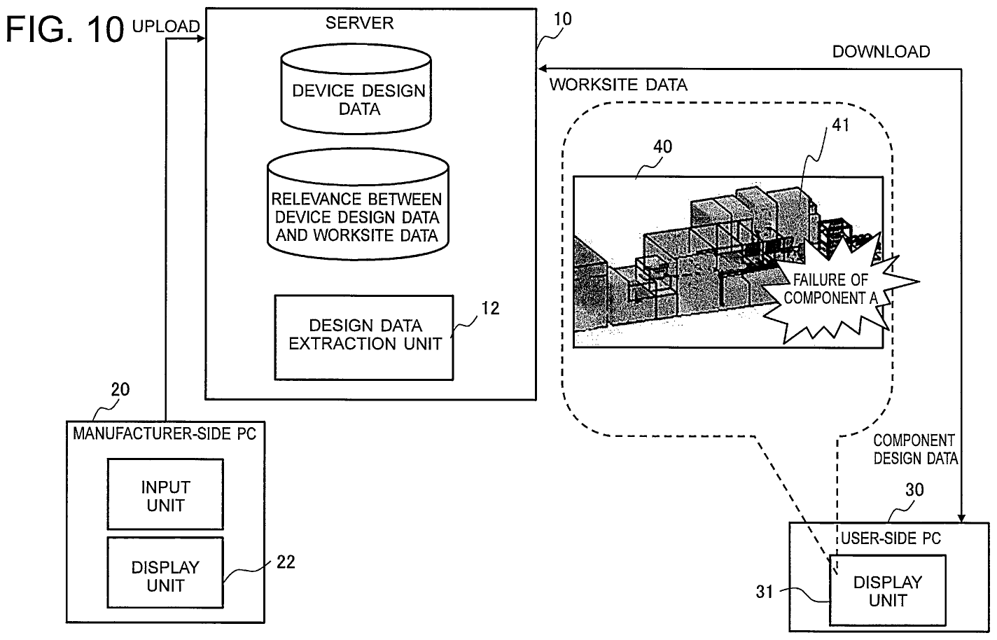

FIG. 10 is a diagram schematically showing the configuration of an information provision system according to a fifth embodiment. FIG. 1 is also referred to in the description of the configuration of the information provision system according to the fifth embodiment. In the information provision system according to the fifth embodiment, the server 10 previously stores abnormality relevance information in which the device design data and abnormality notification data notifying of the contents of abnormality relevant to the target device (namely, worksite data) are associated with each other, and when the abnormality notification data is received, generates the disclosure design data by extracting data from the device design data by referring to the abnormality relevance information.

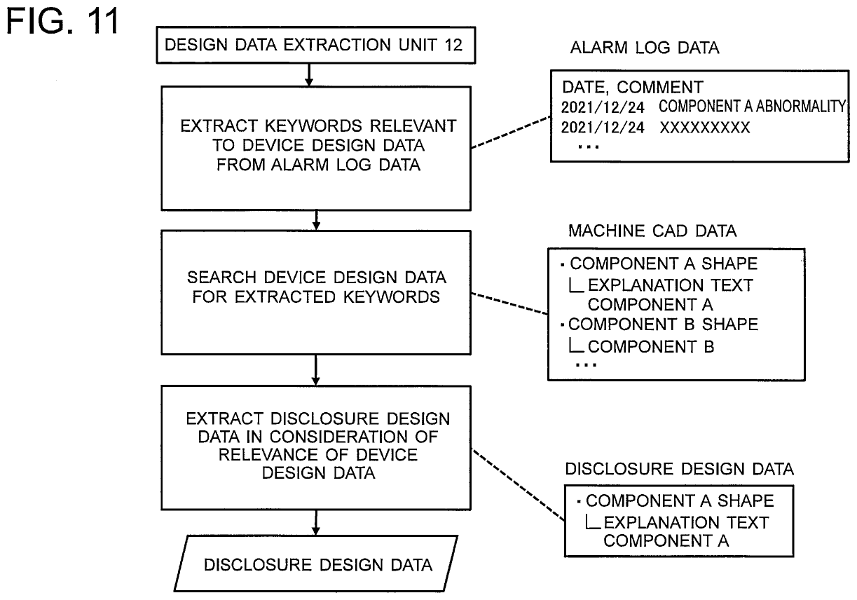

FIG. 11 is a flowchart showing the operation of the information provision system according to the fifth embodiment. FIG. 11 shows a method of linking the device design data with the worksite data, that is, a method of extracting design data corresponding to the worksite data. In FIG. 11, the design data extraction unit 12 first extracts keywords relevant to the device design data from alarm log data. Subsequently, the design data extraction unit 12 searches the device design data (in this example, machine CAD data) for the extracted keywords. Subsequently, the design data extraction unit 12 extracts the disclosure design data in consideration of the relevance of design data.

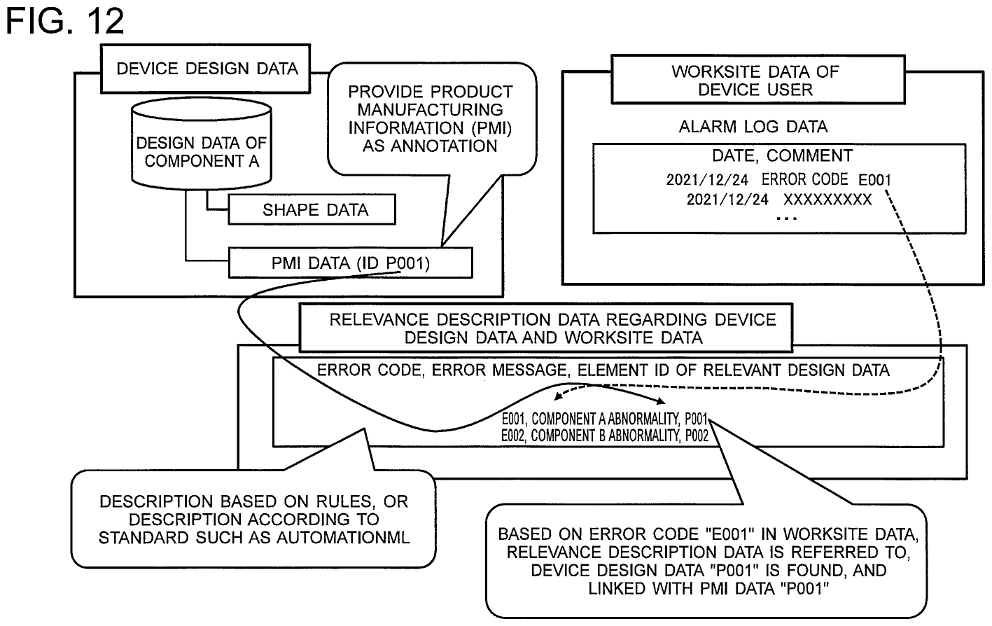

FIG. 12 is an explanatory diagram showing the operation of the information provision system according to the fifth embodiment. FIG. 11 illustrates a case where there exists a common keyword “component A” in the worksite data (alarm log data) and the device design data. In contrast, FIG. 12 illustrates a case where there exists no information directly linking the device design data and the worksite data with each other. As shown in FIG. 12, the configuration of the information provision system can also be a configuration for extracting device design data of the device manufacturer published on the cloud from the worksite data of the device user via the network. Further, the configuration of the information provision system can also be a configuration for ordering the computer on the device user's side to extract device design data from the worksite data after device design data for disclosure is provided from the device manufacturer to the device user. In FIG. 12, “P001” is described in the device design data as the ID of PMI (Product Manufacturing Information) data, “E001” as an error code is described in the worksite data of the device user, and “E001, component A abnormality, P001” is described in relevance description data regarding the device design data and the worksite data. Thus, the design data extraction unit 12 refers to a file describing the relationship between the two items of data, refers to the relevance description data based on the error code “E001” at the worksite, finds the device design data “P001”, and links the data with the PMI data “P001”. The information directly linking the device design data and the worksite data with each other can also be label information, a name or the like assigned to a shape element. Further, the device design data found can be either data in units of files or data in units of elements in a file. In the latter case, it is possible, for example, to identify an element in the design data linked with the worksite data and display the element in enhanced display.

According to the fifth embodiment, design data necessary for each abnormality occurring in the worksite can be extracted automatically. Further, by previously managing the design data in units of elements, an attention part in the design data can be displayed in the enhanced display.

Except for the above-described features, the fifth embodiment is the same as any one of the first to fourth embodiments.

### (6) Modification

The configurations of the information provision systems according to the first to fifth embodiments described above can be appropriately combined with each other.

### DESCRIPTION OF REFERENCE CHARACTERS

10: server (server device), 11: design data management unit, 12: design data extraction unit, 13: design data issuance unit, 14: storage device, 15: cloud service provision unit, 20: manufacturer-side PC (computer on device manufacturer's side), 21: disclosure range designation unit, 22, 106: display unit, 30: user-side PC (computer on device user's side), 31, 206: display unit.

What is claimed is:

1. An information provision system comprising:
processing circuitry
to manage device design data regarding design of a target device provided to a device user, including one or more items of data out of machine design data as data regarding machine design of the target device, electric design data as data regarding electric design of the target device, and control design data as data regarding control design of the target device, by handling each of a plurality of elements constituting the device design data as a unit and linking relevance information indicating relevance between elements in the plurality of elements, with each element;
to generate disclosure design data by extracting a part corresponding to a designated disclosure range from the device design data in units of elements and by referring to the relevance information; and
to issue the disclosure design data while managing the device user's access right and the device user's viewable period regarding the disclosure design data.

2. The information provision system according to claim 1, wherein the processing circuitry generates the disclosure design data by extracting elements corresponding to the disclosure range and elements linked with the elements corresponding to the disclosure range as the part corresponding to the designated disclosure range.

3. The information provision system according to claim 1, comprising a computer on a device provider's side managed by a device provider providing the target device,
wherein the processing circuitry is provided in the computer on the device provider's side.

4. The information provision system according to claim 1, comprising:
a computer on a device provider's side managed by a device provider providing the target device; and
a server computer capable of communication with the computer on the device provider's side via a network,
wherein the processing circuitry are provided in the server computer or a distributed system formed with the server computer and the computer on the device provider's side.

5. The information provision system according to claim 1, wherein
the processing circuitry
dynamically modifies the device design data extracted according to modification of the disclosure range, and
generates modified disclosure design data by extracting a part corresponding to the modified disclosure range from the device design data in units of elements and by referring to the relevance information, and
the processing circuitry issues the modified disclosure design data while managing the device user's access right and the device user's viewable period regarding the modified disclosure design data.

6. The information provision system according to claim 1, wherein
the processing circuitry
previously stores a plurality of templates each determining items of elements of the device design data to be extracted, and
when a command for selecting one of the plurality of templates is inputted, generates the disclosure design data by extracting the device design data from the processing circuitry according to a disclosure range designated by the selected template in units of elements and by referring to the relevance information, and
the processing circuitry issues the modified disclosure design data while managing the device user's access right and the device user's viewable period regarding the modified disclosure design data.

7. The information provision system according to claim 1, comprising:
a computer on a device provider's side managed by a device provider providing the target device; and
a computer on the device user's side managed by the device user,
wherein when a command for sharing a display screen between a first display device of the computer on the device provider's side and a second display device of the computer on the device user's side is inputted, original device design data before designating the disclosure range is displayed on the first display device while an image based on the disclosure design data issued by the processing circuitry is displayed on the second display device.

8. The information provision system according to claim 1, wherein the processing circuitry
previously stores abnormality relevance information in which the device design data and abnormality notification data notifying of contents of abnormality relevant to the target device are associated with each other, and
when the abnormality notification data is received, generates the disclosure design data by extracting data from the device design data by referring to the abnormality relevance information.

9. The information provision system according to claim 1, wherein
the machine design data includes data of a file generated by using a CAD tool for the machine design,
the electric design data includes data of a file generated by using a CAD tool for the electric design, and
the control design data includes data of a file for a program for the control design.

10. An information provision method to be executed by a computer, comprising:
managing device design data regarding design of a target device provided to a device user, including one or more items of data out of machine design data as data regarding machine design of the target device, electric design data as data regarding electric design of the target device, and control design data as data regarding control design of the target device, by handling each of a plurality of elements constituting the device design data as a unit and linking relevance information indicating relevance between elements in the plurality of elements, with each element;
generating disclosure design data by extracting a part corresponding to a designated disclosure range from the device design data in units of elements and by referring to the relevance information; and
issuing the disclosure design data while managing the device user's access right and the device user's viewable period regarding the disclosure design data.

11. A non-transitory computer-readable storage medium storing an information provision program that causes a computer to execute:
managing device design data regarding design of a target device provided to a device user, including one or more items of data out of machine design data as data regarding machine design of the target device, electric design data as data regarding electric design of the target device, and control design data as data regarding control design of the target device, by handling each of a plurality of elements constituting the device design data as a unit and linking relevance information indicating relevance between elements in the plurality of elements, with each element;
generating disclosure design data by extracting a part corresponding to a designated disclosure range from the device design data in units of elements and by referring to the relevance information; and
issuing the disclosure design data while managing the device user's access right and the device user's viewable period regarding the disclosure design data.
